(19) United States
(12) Patent Application Publication
(10) Pub. No.: US 2025/0158555 A1
(43) Pub. Date: May 15, 2025

(54) ELECTRIC MOTOR CONTROL DEVICE AND FAULT DETECTION METHOD

(71) Applicants: Noriyoshi MACHII, Kitanagoya (JP); Koji OZAWA, Nagoya (JP); Hisayoshi KUROSHIMA, Kasugai (JP)

(72) Inventors: Noriyoshi MACHII, Kitanagoya (JP); Koji OZAWA, Nagoya (JP); Hisayoshi KUROSHIMA, Kasugai (JP)

(73) Assignee: NIDEC MOBILITY CORPORATION, Aichi (JP)

(21) Appl. No.: 18/945,437

(22) Filed: Nov. 12, 2024

(30) Foreign Application Priority Data
Nov. 13, 2023 (JP) 2023-192717

(51) Int. Cl. H02P 29/024; H02P 3/02; H02P 5/50

(52) U.S. Cl. CPC H02P 29/0241; H02P 3/02; H02P 5/50

(57) ABSTRACT

An electric motor controller for a plurality of electric motors connected in parallel has a single control unit, a single motor drive circuit, a plurality of shunt resistors connected to a current path of each electric motor, and a plurality of voltage detection circuits for detecting the voltages of the shunt resistors. When the electric motors are in forward, the control unit detects a fault in each electric motor current path based on a comparison of the voltages at both ends of each shunt resistor detected by the voltage detection circuits and a preset first threshold. When the electric motors are in reverse, the control unit detects a fault in each electric motor current path based on the comparison result between the double-end voltages of each shunt resistor detected by the voltage detection circuit and the preset second threshold.

### CROSS-REFERENCE TO RELATED APPLICATIONS

This application is based upon and claims the benefit of priority from Japanese Patent Application No. 2023-192717 filed on Nov. 13, 2023, the entire contents of which are incorporated herein by reference.

### FIELD

One or more embodiments of the present invention relate to a control device for an electric motor used for opening or closing a tailgate at the rear of a vehicle, and more particularly, to detecting an open circuit fault in a current path of the electric motor.

### BACKGROUND

FIG. 13 is a schematic diagram of an electrically operated tailgate. As shown in FIG. 13, a tailgate 51 is provided at a rear of a vehicle Z, such as a four-wheeler. An upper end of the tailgate 51 is supported on an axle 52 provided on a vehicle body 50. The tailgate 51 swings around the axle 52 in an opening direction X or a closing direction Y. A fully closed position of the tailgate is indicated by reference character 51a. A half-open position of the tailgate is indicated by reference character 51b. A fully open position of the tailgate is indicated by reference character 51c. The tailgate 51 is driven by an electric motor that rotates by operation of an operation switch which is not shown in the diagram.

FIG. 14 is a simplified view of a drive mechanism 60 for driving the tailgate 51. The drive mechanism 60 is located between the vehicle body 50 and the tailgate 51. The drive mechanism 60 has a cylindrical body 61, an electric motor 62 housed inside the body 61, an arm 63 that moves in a direction ‘a’ or ‘b’ according to a direction of rotation of the electric motor 62, and a conversion mechanism 64 that converts the rotational motion of the electric motor 62 into linear motion of the arm 63. One end of the body 61 is connected to the vehicle body 50. One end of the arm 63 is connected to the tailgate 51. The other end of the arm 63 is connected to the conversion mechanism 64.

When the electric motor 62 rotates forward, the arm 63 moves in direction ‘a’ through the conversion mechanism 64, which is linked to this rotation. As a result, the tailgate 51 is pushed up by the arm 63 and swung in the opening direction X, causing the tailgate 51 to open. When the electric motor 62 rotates reverse, the arm 63 moves in the direction ‘b’ through the conversion mechanism 64 that is linked to this rotation. As a result, the tailgate 51 is pulled down by the arm 63 and swung in the closing direction Y, causing the tailgate 51 to close.

FIG. 15 is a rear view of the vehicle Z. A pair of the drive mechanisms 60 is provided in both side of the tailgate 51. In other words, a pair of the electric motors 62, which is a driving source of the tailgate 51, is equipped with the left and right sides of the vehicle Z. This increases the driving force to the tailgate 51 and reduces the deflection of the tailgate 51 by balancing the driving force on both sides.

JP-A-H05-344788, JP-A-2020-78199, WO-A1-2020/179041 and JP-A-2000-166294 disclose a device in which a plurality of electric motors for operating one or more objects are driven by a single drive circuit or controlled by a single control circuit. JP-A-2017-172301, JP-A-2017-141577, JP-A-2021-38532, JP-A-2021-139138 disclose a device in which two electric motors for opening or closing a tailgate are controlled by a single control circuit. In a device equipped with multiple electric motors, it is known to measure the voltage at both ends of a shunt resistor connected in series with each electric motor as a method of detecting an open circuit fault occurring in a current path of the electric motor. For example, WO-A1-2020/179041 discloses such a method of detecting the open circuit fault. In this case, if each electric motor rotates in one direction only, one-way current flows through each shunt resistor. Therefore, the open circuit fault can be detected by a simple method of comparing the voltage at both ends of each shunt resistor with a preset threshold value.

### SUMMARY

If each electric motor rotates in forward or reverse, a direction of the current flowing through each shunt resistor is opposite during the rotation. Therefore, a voltage at both ends of each shunt resistor also differs between forward and reverse rotation, so the same method used for electric motors rotating in one direction cannot accurately detect an open circuit fault.

An object according to one or more embodiments of the present invention is to accurately detect a fault in a current path of the electric motor, either in forward or reverse rotation of the electric motor, in a device that controls forward or reverse rotation of electric motors.

According to an aspect of the present invention, there is provided an electric motor control device for electric motors connected in parallel includes: a single motor drive circuit that drives the plurality of electric motors in forward or reverse rotation; a single control unit that outputs control signals for controlling the rotation of each electric motor to the motor drive circuit; a plurality of shunt resistors provided between each electric motor and the motor drive circuit; and a plurality of voltage detection circuits that detect the voltage at both ends of each shunt resistor. When the control signal is a forward command for each electric motor, the control unit compares the detected voltages at both ends of each shunt resistor with a preset first threshold to detect a fault in a current path of each electric motor. When the control signal is a reverse command for each electric motor, the control unit compares the detected voltages at both ends of each shunt resistor with a preset second threshold to detect a fault in the current path of each electric motor.

According to one or more embodiments of the present invention, the electric motor control device is provided with the single control unit and the single motor drive circuit, and thereby detects a fault in the current path of each electric motor individually during forward or reverse rotation of the electric motor.

### BRIEF DESCRIPTION OF THE DRAWINGS

FIG. 1 is a block diagram of an electric motor controller.

FIG. 2 is an electric circuit diagram showing a motor drive circuit.

FIG. 3 is an electric circuit diagram showing a first voltage detection circuit.

FIG. 4 is a motor current path diagram under normal conditions when the motor rotates forward.

FIG. 5 is a motor current path diagram under normal conditions when the motor rotates reverse.

FIG. 6 is a motor current path diagram under an open circuit fault in a first motor system when the motor rotates forward.

FIG. 7 is a motor current path diagram under an open circuit fault in the first motor system when the motor rotates reverse.

FIG. 8 is a motor current path diagram under an open circuit fault in a second motor system when the motor rotates forward.

FIG. 9 is a motor current path diagram under an open circuit fault in the second motor system when the motor rotates reverse.

FIG. 10A is a relationship diagram between two thresholds and a detected voltage.

FIG. 10B is a diagram showing the detected voltages on the H-bridge circuit.

FIG. 11 is a table showing criteria of detecting open circuit faults.

FIG. 12 is a flowchart showing fault detections.

FIG. 13 is a schematic diagram of a tailgate.

FIG. 14 is a simplified view of a tailgate drive mechanism.

FIG. 15 is a rear view of a vehicle.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Embodiments of the present invention will be described with reference to the drawings. Throughout each figure, identical or corresponding parts are marked with the same symbol.

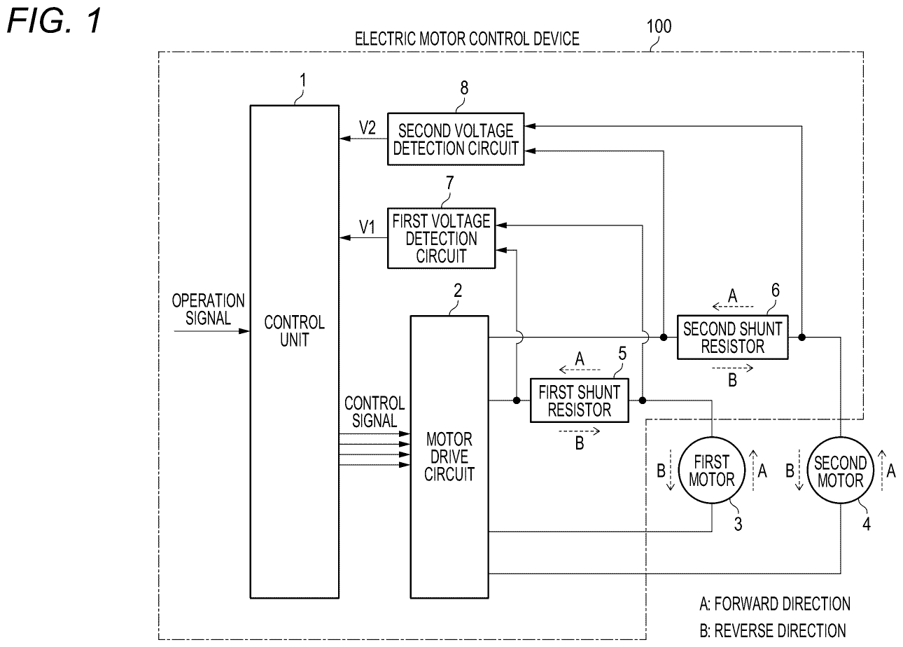

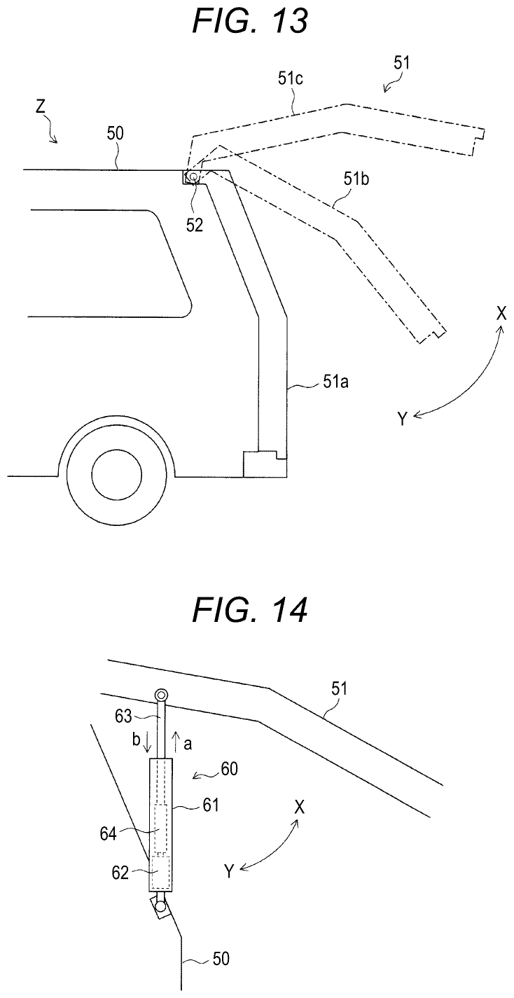

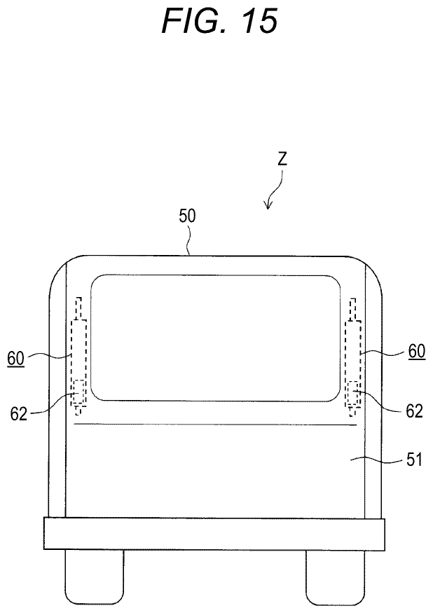

FIG. 1 is a block diagram of an electric motor control device. The electric motor control device 100 controls a rotation of a first motor 3 and a second motor 4. Both of the motors 3 and 4 are a direct-current (DC) electric motors capable of rotating forward or reverse. Both of the motors 3 and 4 open or close a tailgate 51 illustrated in FIGS. 13 through 15. For example, the first motor 3 corresponds to a left electric motor 62 in FIG. 15. The second motor 4 corresponds to a right electric motor 62 in FIG. 15.

The electric motor controller 100 includes a single control unit 1, a single motor drive circuit 2, a first shunt resistor 5, a second shunt resistor 6, a first voltage detection circuit 7, and a second voltage detection circuit 8.

When the first motor 3 is in forward rotation, the motor drive circuit 2 flows motor current in a direction A. When the first motor 3 is in reverse rotation, the motor drive circuit 2 flows motor current in a direction B. Similarly, when the second motor 4 is in forward rotation, the motor drive circuit 2 flows motor current in the direction A. When the second motor 4 is in reverse rotation, the motor drive circuit 2 flows motor current in the direction B.

The control unit 1 is configured with a central processing unit and other components. An operation signal is input to the control unit 1 to open or close the tailgate 51. The operation signal is generated by an operation of an operation unit in a vehicle or an electronic key. The diagram of the operation unit is omitted. The control unit 1 outputs control signals to the motor drive circuit 2 to control the rotation of the first motor 3 and the second motor 4 based on the input operation signal. The control signal for forward rotation of both of the motor 3 and motor 4 is a forward rotation command. The control signal for reverse rotation of both of the motor 3 and the motor 4 is a reverse command.

The motor drive circuit 2 configured with an H-bridge circuit with four switching elements, as described below. This motor drive circuit 2 energizes the first motor 3 and the second motor 4 based on the control signal from the control unit 1 to rotate both of the motor 3 and the motor 4 forward or reverse.

The first shunt resistor 5 is provided between the first motor 3 and the motor drive circuit 2. When the first motor 3 rotates forward, the motor drive circuit 2 applies a motor current in the direction A to the first shunt resistor 5. When the first motor 3 rotates reverse, the motor drive circuit 2 applies the motor current in the direction B to the first shunt resistor 5.

The second shunt resistor 6 is provided between the second motor 4 and the motor drive circuit 2. When the second motor 4 rotates forward, the motor drive circuit 2 applies the motor current in the direction A to the second shunt resistor 6. When the second motor 4 rotates reverse, the motor drive circuit 2 applies the motor current in the direction B to the second shunt resistor 6.

The first voltage detection circuit 7 detects a voltage at both ends of the first shunt resistor 5. The detected values of the voltage of the shunt resistor 5 differ depending on whether the direction of the motor current flowing through the first shunt resistor 5 is the direction A or the direction B. The first voltage detection circuit 7 outputs the detected value V1 of the voltage at both ends of the first shunt resistor 5 to the control unit 1.

The second voltage detection circuit 8 detects a voltage at both ends of the second shunt resistor 6. The detected values of the voltage differ depending on whether the directions of the motor current flowing through the second shunt resistor 6 is the direction A or the direction B. The second voltage detection circuit 8 outputs the detected value V2 of the voltage at both ends of the second shunt resistor 6 to the control unit 1.

The control unit 1 detects open circuit faults in current paths of the first motor 3 and the second motor 4, based on the voltages at both ends of the shunt resistor 5 and the shunt resistor 6 input from the voltage detection circuit 7 and the voltage circuit 8. This detection method will be explained in detail later.

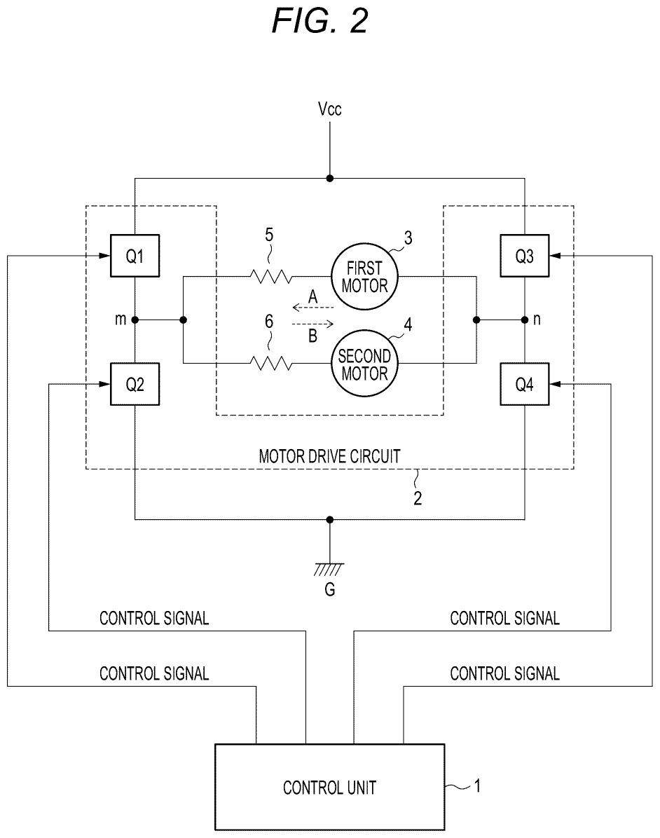

FIG. 2 is a circuit diagram of the motor drive circuit 2. The motor drive circuit 2 is configured with a H-bridge circuit with four switching elements Q1 to Q4. Each switching element Q1 to Q4 is configured with a field effect transistor (FET), for example. The switching elements Q1 and Q2 are connected in series between a DC power supply Vcc and a ground G. The switching elements Q3 and Q4 are also connected in series between the DC power supply Vcc and the ground G. The series circuit of the first motor 3 and the first shunt resistor 5 and the series circuit of the second motor 4 and the second shunt resistor 6 are connected in parallel between the connection points ‘m’ of the switching elements Q1 and Q2 and the connection points ‘n’ of the switching elements Q3 and Q4.

Each of the switching elements Q1 to Q4 is individually given the control signal from the control unit 1. This control signal is a binary signal of high level or low level. Among the switching elements Q1 to Q4, the switching element is turned ON when the high level signal (hereinafter referred to as “H signal”) is given. The switching element is turned OFF when the low level signal (hereinafter referred to as “L signal”) is given. Depending on the ON state or OFF state of these switching elements Q1 to Q4, motor current flows in the direction A or the direction B to the first motor 3 and the second motor 4, and the first shunt resistor 5 and the second shunt resistor 6. Details are described later.

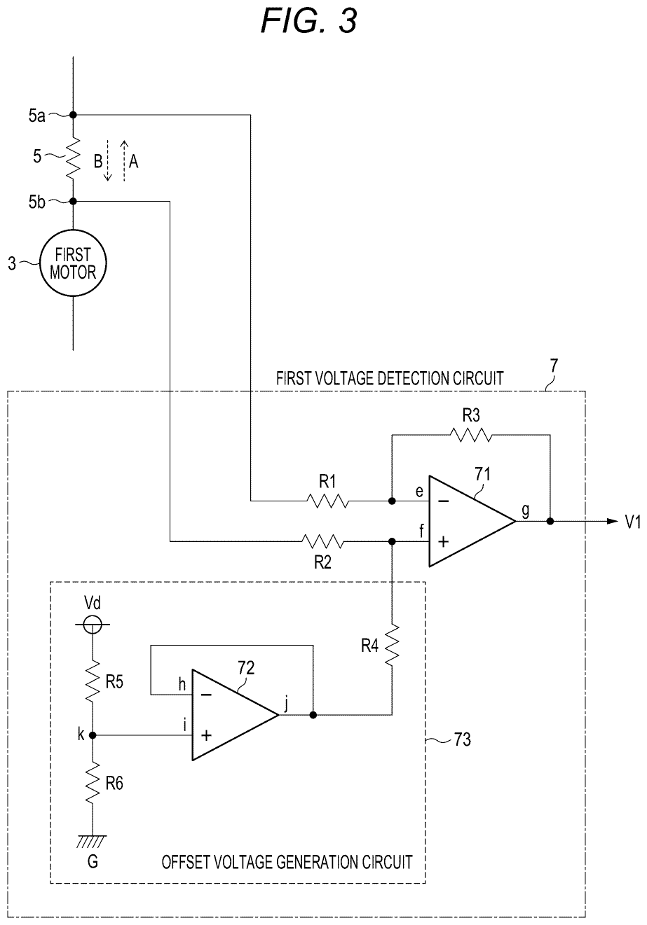

FIG. 3 shows a circuit diagram of the first voltage detection circuit 7. The second voltage detection circuit 8 has the same configuration as the first voltage detection circuit 7. In the following, only the first voltage detection circuit 7 will be described.

The first voltage detection circuit 7 is configured with differential amplifiers 71 and 72 and resistors R1 to R6. A negative side input terminal ‘e’ (hereinafter referred as “negative terminal”) of a differential amplifier 71 is connected to one end 5a of the first shunt resistor 5 via the resistor R1. A positive side input terminal ‘f (hereinafter referred as “positive terminal”) of the differential amplifier 71 is connected to the other end 5b of the first shunt resistor 5 via the resistor R2. The resistor R3 is connected between the negative terminal ‘e’ and an output terminal ‘g’ of the differential amplifier 71. The differential amplifier 71 calculates and amplifies the difference between the potential of the positive terminal ‘f and the potential of the negative terminal ‘e’. The differential amplifier 71 outputs a value of a detected voltage V1 at both ends of the first shunt register 5 to the control unit 1 of FIG. 1.

A negative terminal ‘h’ of the differential amplifier 72 is connected to an output terminal ‘j’. The output terminal ‘j’ is connected to the positive terminal ‘f of the differential amplifier 71 via the resistor R4. A positive terminal ‘i’ of the differential amplifier 72 is connected to a connection point ‘k’ of the resistors R5 and R6. The resistors R5 and R6 are connected in series between a DC power supply Vd and the ground G. The differential amplifier 72 and the resistors R4 to R6 configure an offset voltage generation circuit 73. The offset voltage generation circuit 73 converts the voltage of the DC power supply Vd, which is divided by the resistors R5 and R6, into an offset voltage of a predetermined value by the differential amplifier 72 and the resistor R4, and gives this offset voltage to the positive terminal ‘f’ of the differential amplifier 71. The reason for the offset voltage generation circuit 73 is as follows.

In FIG. 3, when a direction of the motor current flowing into the first shunt resistor 5 is the direction A, the potential of one end 5a of the first shunt resistor 5 is lower than the potential of the other end 5b of the first shunt resistor 5. Therefore, the potential of the negative terminal ‘e’ of the differential amplifier 71 is also lower than the potential of the positive terminal ‘f’, so the differential amplifier 71 can correctly calculate the voltage at both ends of the first shunt resistor 5. If, however, a motor current is in the direction B, the potential of one end 5a of the first shunt resistor 5 is higher than the potential of the other end 5b of the first shunt resistor 5. Therefore, the potential of the negative terminal ‘e’ of the differential amplifier 71 becomes higher than the potential of the positive terminal ‘f, and the differential amplifier 71 cannot correctly calculate the voltage at both ends of the first shunt resistor 5. Therefore, an offset voltage is given to the positive terminal ‘f of the differential amplifier 71 by the offset voltage generation circuit 73 to make the potential of the positive terminal ‘f always higher than the potential of the negative terminal ‘e’. This allows the differential amplifier 71 to correctly calculate the voltage at both ends of the first shunt resistor 5 regardless of the direction of the motor current.

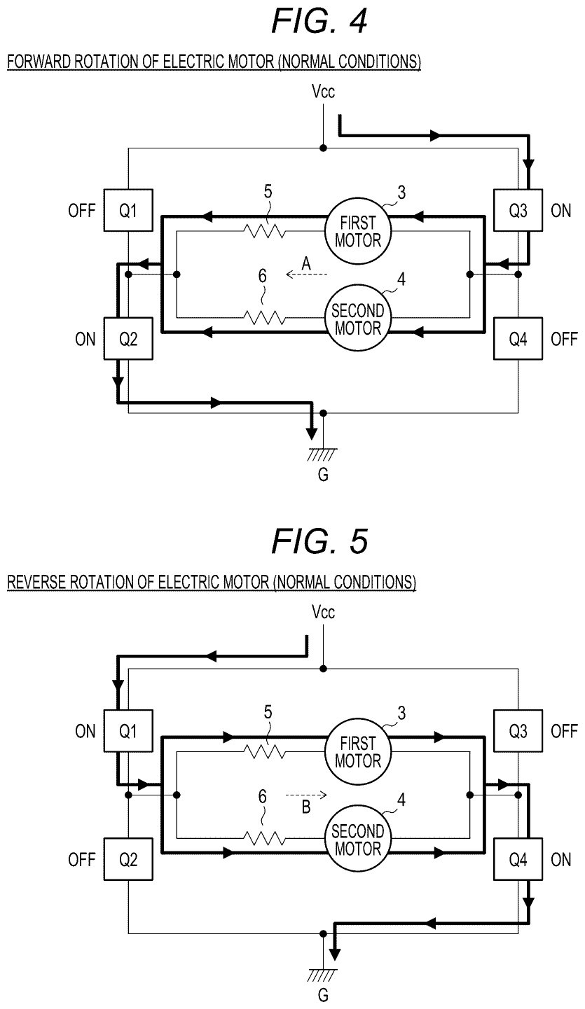

Next, the paths of the motor currents flowing through the first motor 3 and second motor 4 are explained with reference to FIGS. 4 through 9.

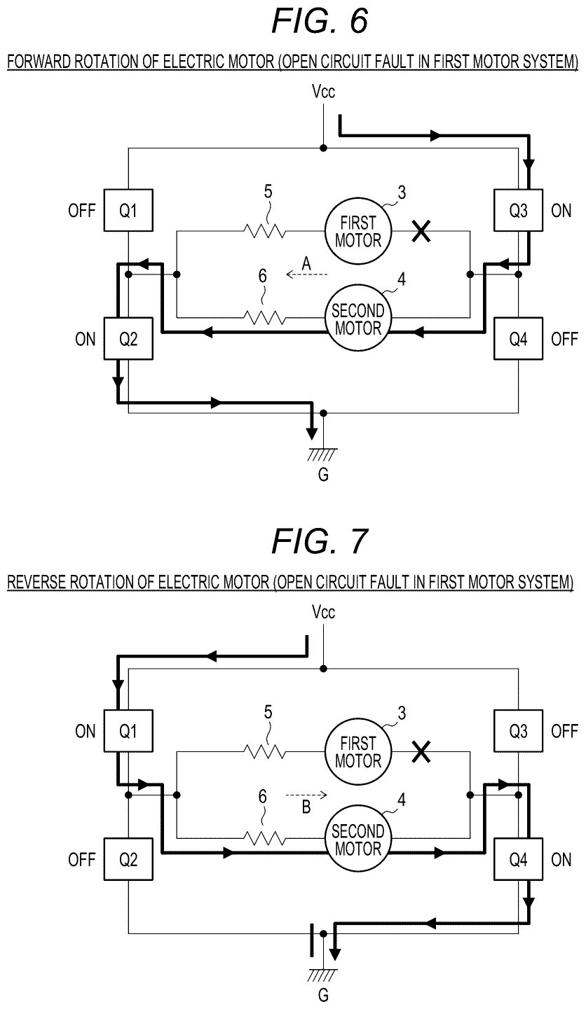

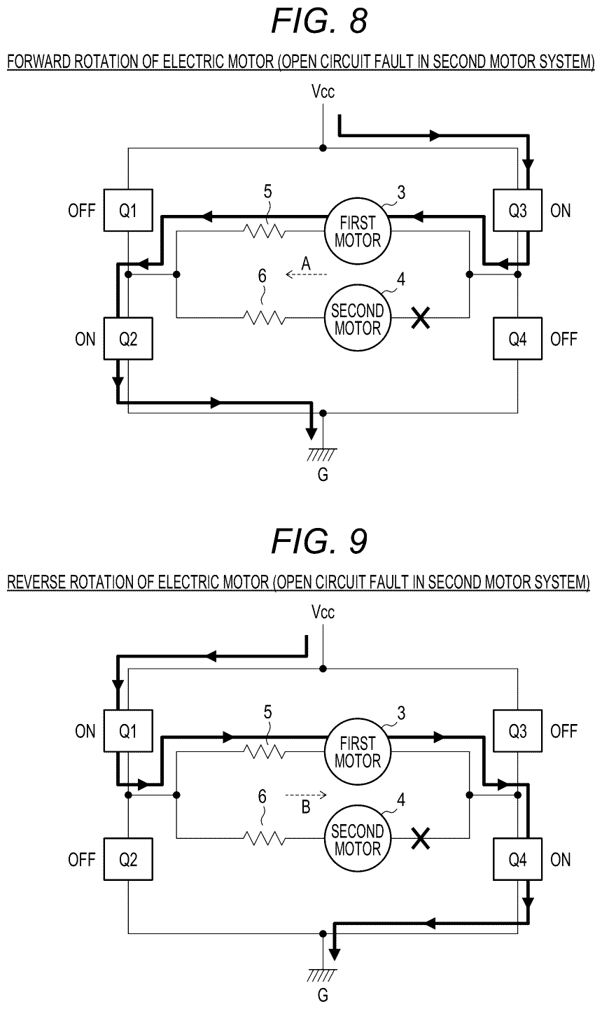

FIG. 4 is a diagram showing motor current paths of both motors 3 and 4 under normal conditions during forward rotation. The control signal output from the control unit 1 to the motor drive circuit 2 when the motors is to be rotated forward is a forward rotation command. This forward rotation command is configured with H signals to turn on switching elements Q2 and Q3 and L signals to turn off switching elements Q1 and Q4. The same is true in FIGS. 6 and 8. When the switching elements Q2 and Q3 are turned on, the motor current in the direction A flows to each of the motors 3 and 4 along the paths indicated by the bold arrows. This motor current also flows through each shunt resistor 5 and 6, causing a voltage drop across each shunt resistor 5 and 6. This voltage drop is detected by the first voltage detection circuit 7 and the second voltage detection circuit 8 in FIG. 1 as the voltages at both ends of each shunt resistor 5 and 6, respectively. The same is true in FIGS. 5 through 9.

FIG. 5 is a diagram showing motor current paths of both motors 3 and 4 under normal conditions during reverse rotation. The control signal output from the control unit 1 to the motor drive circuit 2 when the motors is to be rotated reverse is a reverse rotation command. This reverse rotation command is configured with H signals to turn on switching elements Q1 and Q4 and L signals to turn off switching elements Q2 and Q3. The same is true in FIGS. 7 and 9. When the switching elements Q1 and Q4 are turned on, the motor current in the direction A flows to each of the motors 3 and 4 along the paths indicated by the bold arrows. The motor current also flows through each shunt resistor 5 and 6, causing a voltage drop across each shunt resistor 5 and 6. In this case, since the direction of the motor current is opposite to that in FIG. 4, the voltages at both ends of each shunt resistor 5 and 6 is smaller than in FIG. 4.

FIG. 6 is a diagram showing a motor current path when an open circuit fault occurs in a current path of the first motor 3 (hereinafter referred to as “first motor system”) during the forward rotation. The cause of the open circuit fault could be a disconnection between the motor terminals and the power feed cable. The same is true in FIGS. 7 through 9. In FIG. 6, the motor current in the direction A flows to the second motor 4 in the current path indicated by a bold arrow due to the ON of switching elements Q2 and Q3. On the other hand, no motor current flows to the first motor 3 on the side where the disconnection occurred. Therefore, only the voltage at both ends of the second shunt resistor 6 is detected by the second voltage detection circuit 8.

FIG. 7 is a diagram showing a motor current path in the case of an open circuit fault in the first motor system during the reverse rotation. In this case, the motor current flows in the direction B to the second motor 4 in the path indicated by a bold arrow due to the ON of switching elements Q1 and Q4. On the other hand, no motor current flows to the first motor 3 on the side where the open circuit fault occurred. Therefore, only the voltage at both ends of the second shunt resistor 6 is detected by the second voltage detection circuit 8. In this case, since the direction of the motor current is opposite to that in FIG. 6, the voltage at both ends of the second shunt resistor 6 is smaller than that in FIG. 6.

FIG. 8 is a diagram showing a motor current path in the case of an open circuit fault in the current path of the second motor 4 (hereinafter referred to as “second motor system”) during the forward rotation. In this case, motor current in the direction A flows to the first motor 3 in the path indicated by a bold arrow due to the ON of switching elements Q2 and Q3. On the other hand, no motor current flows to the second motor 4 on the side where the open circuit occurred. Therefore, only the voltage at both ends of the first shunt resistor 5 is detected by the first voltage detection circuit 7.

FIG. 9 is a diagram showing a motor current path in the case of an open circuit fault in the second motor system during the reverse rotation. In this case, the motor current flows in the direction B to the first motor 3 in the path indicated by a bold arrow due to the ON of switching elements Q1 and Q4. On the other hand, no motor current flows to the second motor 4 on the side where the open circuit fault occurred. Therefore, only the voltage at both ends of the first shunt resistor 5 is detected by the first voltage detection circuit 7. In this case, since the direction of the motor current is opposite to that in FIG. 8, the voltage at both ends of the first shunt resistor 5 is smaller than in FIG. 8.

The voltage at both ends of the first shunt resistor 5 detected by the first voltage detection circuit 7 and the voltage at both ends of the second shunt resistor 6 detected by the second voltage detection circuit 8 are input to the control unit 1, respectively. The control unit 1 detects the open circuit faults in the first and second motor systems based on the kind of control signal (forward or reverse rotation command), the double-end voltages of each shunt resistor 5 and 6, and the threshold values described below. The details of this detection method are described below.

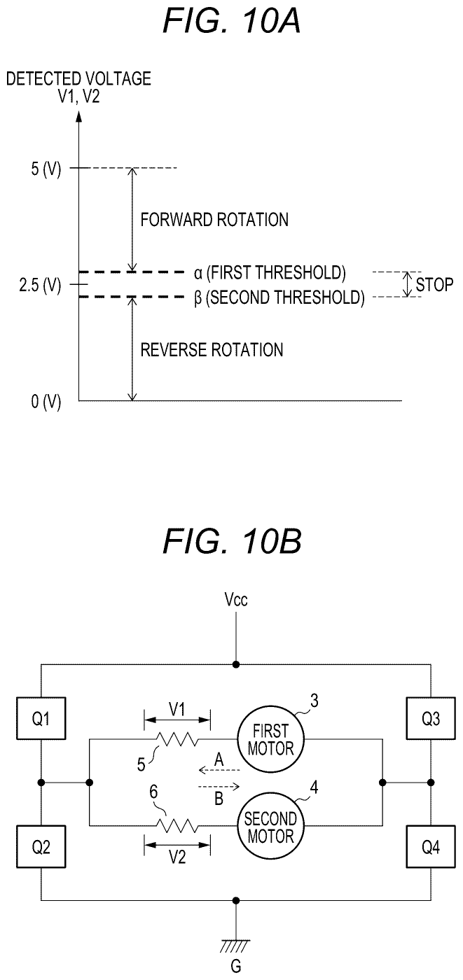

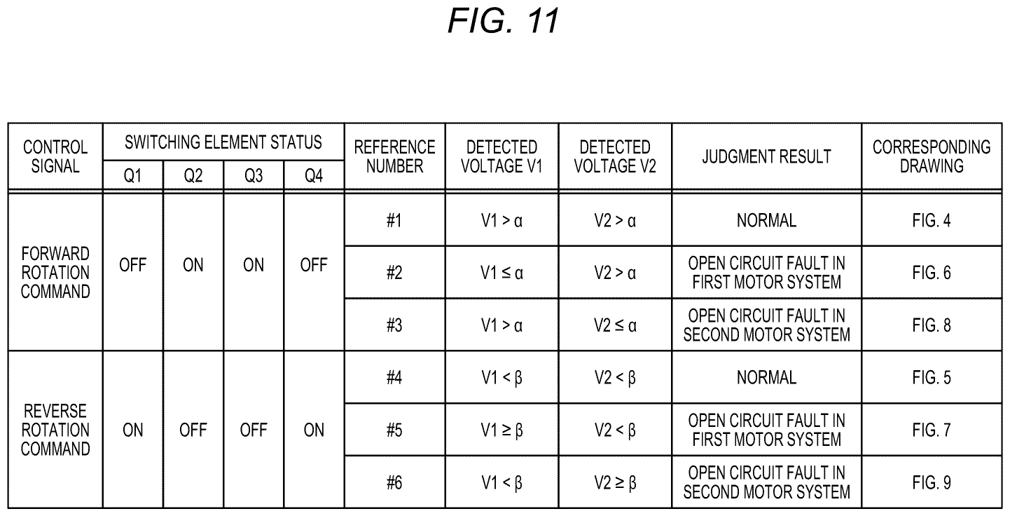

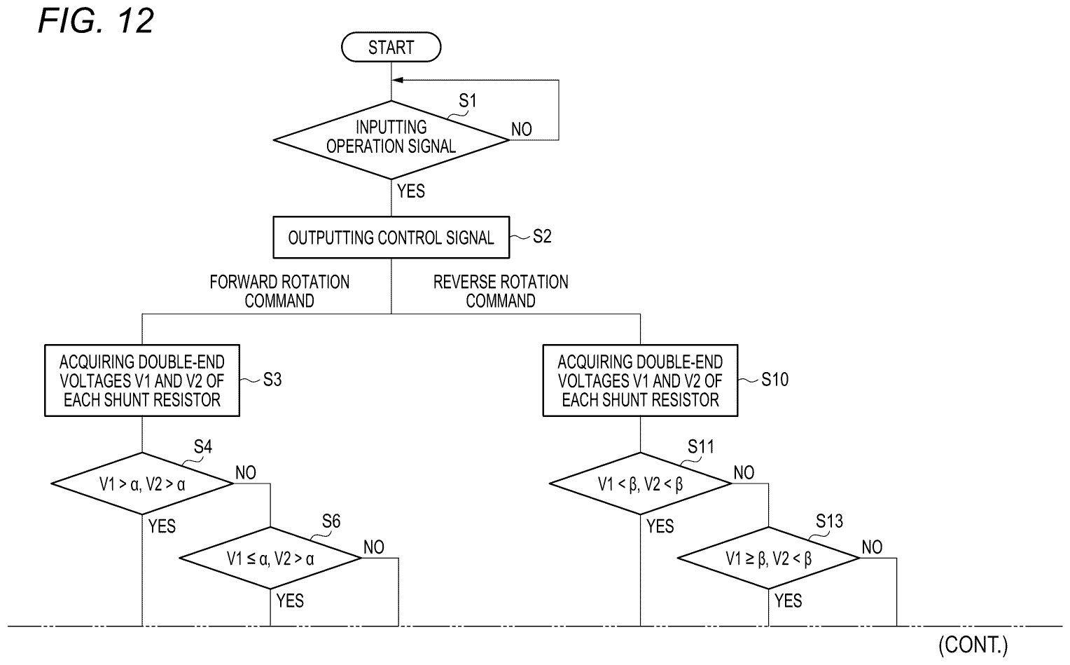

FIG. 10A is a relationship diagram between the two threshold values a and B used to detect open circuit faults and the voltages V1 and V2 detected by the respective voltage detection circuits 7 and 8. FIG. 10B is a diagram showing that the detected voltage V1 is the voltage at both ends of the first shunt resistor 5, and the detected voltage V2 is the voltage at both ends of the second shunt resistor 6.

In FIG. 10A, the detected voltages V1 and V2 vary between zero and 5 volts. While the first motor 3 and the second motor 4 are stopped, the detected voltages V1 and V2 are both approximately 2.5 volts. The first threshold value α is preset slightly larger than this 2.5 volts. The second threshold value β is preset slightly smaller than 2.5 volts. For example, the first threshold value α should be preset according to the upper limit of the detected voltage variation while the first motor 3 and the second motor 4 are stopped. The second threshold value β should be preset according to the lower limit of the detected voltage variation while the first motor 3 and the second motor 4 are stopped.

When each of the motors 3 and 4 is in forward rotation, if there is no open circuit fault in any of the motor systems, the motor current in the direction A shown in FIG. 10B flows through each shunt resistor 5 and 6. In this case, the detected voltages V1 and V2 are both larger than the first threshold value α. However, when the open circuit fault occurs in the first motor system, no motor current flows in the first shunt resistor 5, so the detected voltage V1 is less than the first threshold value α. Also, when the open circuit fault occurs in the second motor system, no motor current flows through the second shunt resistor 6, so the detected voltage V2 is less than the first threshold a.

On the other hand, when each of the motors 3 and 4 is in reverse, if there is no open circuit fault in any of the motor systems, the motor current in the direction B shown in FIG. 10B flows through each shunt resistor 5 and 6. In this case, the detected voltages V1 and V2 are both smaller than the second threshold B. However, when the open circuit fault occurs in the first motor system, no motor current flows in the first shunt resistor 5, so the detected voltage V1 is greater than the second threshold B. When the open circuit fault occurs in the second motor system, no motor current flows through the second shunt resistor 6, so the detected voltage V2 is greater than the second threshold B.

In this way, during forward rotation of each motor 3 and 4, the open circuit fault in each motor system can be detected based on the comparison result between the detected voltages V1 and V2 and the preset first threshold value α. During reverse rotation of each of the motor 3 and 4, the open circuit fault in each motor system can be detected based on the comparison result between the detected voltages V1 and V2 and the preset second threshold value β.

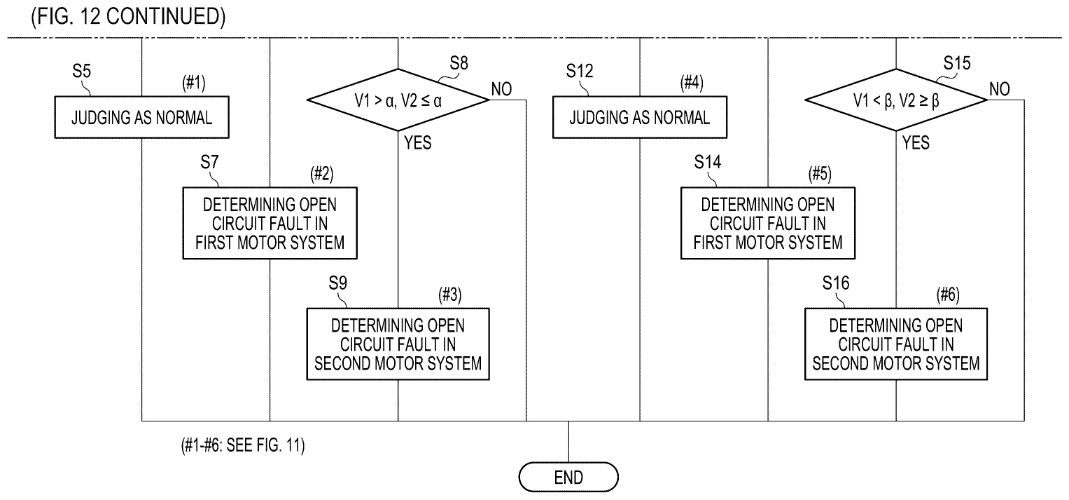

FIG. 11 is a table showing criteria for above mentioned detecting open circuit faults for the six cases shown in FIGS. 4 through 9.

Reference numbers #1 to #3 indicate fault criteria during the motor forward rotation. In a condition of the criteria #1, the control unit 1 judges that no open circuit fault has occurred in either motor system because the detected voltages V1 and V2 are both greater than the first threshold value α. The current path at this condition is shown in FIG. 4. In a condition of the criteria #2, the detected voltage V1 is less than the first threshold a, so the control unit 1 judges that the open circuit fault has occurred in the first motor system. The current path at this condition is as shown in FIG. 6. In a condition of the criteria #3, the detected voltage V2 is less than the first threshold a, so the control unit 1 judges that the open circuit fault has occurred in the second motor system. The current path at this condition is shown in FIG. 8.

Reference numbers #4 to #6 indicate fault criteria during the motor reverse rotation. In a condition of the criteria #4, the control unit 1 judges that no open circuit fault has occurred in either motor system because the detected voltages V1 and V2 are both smaller than the second threshold B. The current path at this condition is shown in FIG. 5. In a condition of the criteria #5, the detected voltage V1 is greater than the second threshold B, so the control unit 1 judges that the open circuit fault has occurred in the first motor system. The current path at this condition is as shown in FIG. 7. In a condition of the criteria #6, the detected voltage V2 is above the second threshold B, so the control unit 1 judges that the open circuit fault has occurred in the second motor system. The current path at this condition is shown in FIG. 9.

FIG. 12 is a flowchart showing the fault detection methods. Each processing step in this flowchart is executed by the control unit 1. The references #1 to #6 appended to the flowchart represent the reference numbers shown in FIG. 11.

In step S1, control unit 1 waits for the operation signal to be input. When the operation signal is input to the control unit 1, in step S2, the control unit 1 outputs a control signal corresponding to the operation signal to the motor drive circuit 2. For example, if the operation signal is a signal indicating the opening of the tailgate 51 (see FIG. 13), the control unit 1 outputs the aforementioned forward rotation command as the control signal. If the operation signal is a signal that indicating the closing of the tailgate 51, then the control unit 1 outputs the aforementioned reverse rotation command as the control signal.

If the control signal is a forward command, steps S3 to S9 are executed. In step S3, control unit 1 acquires the double-end voltages V1 and V2 of each shunt resistor 5 and 6 detected by each voltage detection circuit 7 and 8. Next, in step S4, the control unit 1 compares the double-end voltages V1 and V2 with the first threshold value α to determine whether V1>α and V2>α. If, as a result of the judgment, V1>α and V2>α, the control unit 1 judges that both motor systems are normal, i.e., no open circuit fault, in step S5.

If the judgment result in step S4 is not V1>α and V2>α, the control unit 1 judges whether V1≤α and V2>α in step S6. If the result of the determination is that V1≤α and V2>α, the control unit 1 determines in step S7 that an open circuit fault has occurred in the first motor system. If V1≤α and V2>α are not present in step S6, the control unit 1 determines whether V1>α and V2≤α in step S8. If, as a result of the determination, V1>α and V2≤α, the control unit 1 determines in step S9 that an open circuit fault has occurred in the second motor system. If V1>α and V2≤α are not present in step S8, the control unit 1 terminates the process.

On the other hand, if the control signal is a reverse command, the control unit 1 executes processing steps S10 to S16. In step S10, control unit 1 acquires the double-end voltages V1 and V2 of each shunt resistor 5 and 6 detected by each voltage detection circuit 7 and 8. Next, in step S11, the control unit 1 compares the double-end voltages V1 and V2 with the second threshold value β to determine whether V1<β and V2<β. If, as a result of the judgment, V1<β and V2<β, the control unit 1 judges that both motor systems are normal, i.e., no open circuit fault, in step S12.

If the judgment result in step S11 is not V1<β and V2<β, the control unit 1 judges whether V1≥β and V2<β in step S13. If the result of the determination is that V1≥β and V2<β, the control unit 1 determines in step S14 that an open circuit fault has occurred in the first motor system. If V1≥β and V2<β in step S13, the control unit 1 determines whether V1<β and V2≥β in step S15. If, as a result of the determination, V1<β and V2>B, the control unit 1 determines in step S16 that an open circuit fault has occurred in the second motor system. If V1<β and V2≥β is not V1<β and V2≥β in step S15, the control unit 1 terminates the process.

In the embodiment described above, the electric motor controller 100 that controls the two motors 3 and 4 has the single control unit 1, the single motor drive circuit 2, two shunt resistors 5 and 6, and two voltage detection circuits 7 and 8. During motor forward rotation, the control unit 1 detects the open circuit fault in the two motor systems separately based on the comparison results between the double-end voltages V1 and V2 of each shunt resistor 5 and 6 detected by each voltage detection circuit 7 and 8 and the first threshold value α. In addition, when the motor is in reverse, the control unit 1 detects the open circuit faults in the two motor systems individually based on the comparison results between the double-end voltages V1 and V2 of each shunt resistor 5 and 6 and the second threshold value β.

Therefore, even if the open circuit faults in the two motor systems is separately detected in each of the forward and reverse rotation of motors 3 and 4, only one control unit 1 and motor drive circuit 2 need to be installed respectively. Also, shunt resistors 5 and 6 and voltage detection circuits 7 and 8 need only two each, i.e., as many as the number of motors 3 and 4. Therefore, according to this embodiment, a simple circuit configuration with a small number of parts can accurately detect open circuit faults in the two motor systems in both forward and reverse rotation of motors 3 and 4.

In addition to the embodiments described above, various other embodiments can be employed in the present invention, including the following.

In FIG. 11, it is assumed that an open circuit fault has occurred in one of the first and second motor systems, but the invention is also effective when the open circuit fault occurs in both motor systems. In this case, the control unit 1 judges that an open circuit fault has occurred in both motor systems if V1≤α and V2≤α during motor forward rotation. If V1≥β and V2≥β at the time of motor reverse rotation, the control unit 1 judges that the open circuit fault has occurred in both motor systems.

In FIG. 1, two electric motors, the first motor 3 and the second motor 4, are provided, but three or more electric motors may be provided. In this case, shunt resistors and voltage detection circuits are provided for the number of electric motors, respectively.

For the first voltage detection circuit 7, the circuit configuration shown in FIG. 3 is an example and may be equipped with other circuit configurations. The same applies to the second voltage detection circuit 8.

In FIGS. 10A and 10B, the example of detected voltages V1 and V2 varying between zero and 5 volts is given, but this is just one example, and the upper and lower limits of the variation range of detected voltages V1 and V2 may be other values.

In the embodiment described above, the tailgates 51 of the vehicle is used as examples of objects to be driven by the first and second motors 3 and 4, but the invention can also be applied to control devices for electric motors that drive objects other than the tailgate.

1. An electric motor control device for electric motors connected in parallel comprising:
a single motor drive circuit that drives the plurality of electric motors in forward or reverse rotation;
a single control unit that outputs control signals for controlling the rotation of each electric motor to the motor drive circuit;
a plurality of shunt resistors provided between each electric motor and the motor drive circuit; and
a plurality of voltage detection circuits that detect the voltage at both ends of each shunt resistor,
when the control signal is a forward command for each electric motor, the control unit compares the detected voltages at both ends of each shunt resistor with a preset first threshold to detect a fault in a current path of each electric motor,
when the control signal is a reverse command for each electric motor, the control unit compares the detected voltages at both ends of each shunt resistor with a preset second threshold to detect a fault in the current path of each electric motor.

2. The electric motor control device according to claim 1,
wherein the control unit detects an open circuit fault has in the current path of the electric motor connected to the shunt resistor if the voltage at either end of each shunt resistor is below the preset first threshold when the control signal is a forward command.

3. The electric motor control device according to claim 1,
wherein the control unit determines an open circuit fault in the current path of the electric motor connected to the shunt resistor if the voltage at either end of each shunt resistor is above the second threshold when the control signal is a reverse command.

4. The electric motor control device according to claim 1,
wherein the preset first threshold is greater than the voltage at both ends of each shunt resistor while each electric motor is stopped, and
the preset second threshold is smaller than the voltage at both ends of each shunt resistor while each electric motor is stopped.

5. A method for detecting faults in an electric motor control device for electric motors connected in parallel comprising:
a single motor drive circuit that drives a single control unit that outputs control signals for controlling the rotation of each electric motor to the motor drive circuit,
a plurality of shunt resistors provided between each electric motor and the motor drive circuit, and
a plurality of voltage detection circuits that detect the voltage at both ends of each shunt resistor,
wherein the control unit includes steps of outputting the control signal to the motor drive circuit,
comparing the detected voltage at both ends of each shunt resistor with a preset first threshold when the control signal is a forward command for each electric motor,
comparing the detected voltage at both ends of each shunt resistor with a preset second threshold when the control signal is a reverse command for each electric motor, and
detecting a fault in a current path of each electric motor based on the comparison results between each voltage and each threshold.
